(19) United States
(12) Patent Application Publication
(10) Pub. No.: US 2003/0156568 A1
(43) Pub. Date: Aug. 21, 2003

(54) Method of selecting a coding format in a terminal of a communications system

(75) Inventors: Frederic Reich, Villabe (FR); Alban Couturier, Chatillon (FR); Philippe Dauchy, Paris (FR); Patricia Reymond, Palaiseau (FR); Bruno Bonnin, Antony (FR); Alberto Conte, Paris (FR); Francois-Xavier Guitton, Saint Jean De Boiseau (FR); Pierre Massart, Nantes (FR)

Correspondence Address: SUGHRUE MION, PLLC, Suite 800, 2100 Pennsylvania Avenu, N.W., Washington, DC, 20037-3213, US

(73) Assignee: ALCATEL

(21) Appl. No.: 10/365,466

(22) Filed: Feb. 13, 2003

(30) Foreign Application Priority Data
Feb. 18, 2002 (FR) 02 02 016

(51) Int. Cl. H04Q 7/24

(52) U.S. Cl. 370/338

(57) ABSTRACT

The invention relates to a method of selecting multimedia data coding formats in a communications system having at least two terminals suitable for exchanging multimedia data. Each terminal has a set of coding formats listing the formats which it is capable of processing in reception and formats which it is capable of applying to multimedia data in transmission. Prior to any exchange of data between two terminals, each terminal sends its set of coding formats to the other terminal via a server. According to the invention, the server is connected to code format conversion means and, where necessary, it enlarges each set of coding formats received from a terminal as a function of the conversion means available to it, prior to forwarding the possibly enlarged set to the other terminal. In this way, the coding and decoding abilities of terminals in the system are enriched virtually, thereby reducing the number of calls that fail.

The present invention relates to a method of selecting multimedia data coding formats in a communications system comprising at least two terminals suitable for exchanging multimedia data between each other.

### BACKGROUND OF THE INVENTION

This code selection is generally performed prior to multimedia data being exchanged between two terminals of the communications system. The term “multimedia data” is used to cover any type of digital data such as voice (telephony), text, or video (images).

The present invention is described more particularly in the context of communications systems having terminals operating in application of session initiation protocol (SIP) or H323 protocol, but that does not imply any limitation on the scope of the invention to communications systems of that type.

At present, prior to two terminals in a communications system exchanging multimedia data, said terminals select the coding format that is to be used for encoding all of the multimedia data transmitted by one or the other of the terminals so as to ensure that the data can be decoded by the terminal receiving said multimedia data. There is no guarantee that all of the terminals in a communications system have the same coding and/or decoding facilities for use with multimedia data.

FIG. 1 illustrates a multimedia data coding format being selected in a communications system having two terminals T1 and T2 operating in application of the SIP protocol. In this figure, the two terminals T1 and T2 seek to exchange multimedia data. Prior to sending any multimedia data from T1 to T2, it is necessary for terminal T1 to select for this purpose an encoding format which it can apply to the multimedia data that is to be sent and that the terminal T2 can process on reception. Similarly, in order to send multimedia data from T2 to T1, the terminal T2 needs to select a coding format which it can apply to the multimedia data it is to send and which the terminal T1 can process on reception.

For this purpose, the terminal T1 sends to the terminal T2 via a proxy server S a set of coding formats covering the coding formats which it is capable of applying to multimedia data on transmission, and those formats which it is capable of processing on reception. This set of formats is referred to below as E1. The corresponding set of formats associated with the terminal T2 is written E2. In the description below, the terms “transmit” coding format and “receive” coding format of a given terminal designate respectively a coding format that the terminal is capable of applying to data it transmits and a coding format that it is capable of decoding on reception.

This step of sending the set E1 to the server S and then to the terminal T2 is represented in FIG. 1 by two arrows respectively connecting the terminal T1 to the server S and the server S to the terminal T2, and above these arrows there is written the instruction “INVITE(E1)”.

If the terminal T2 is capable of decoding at least one transmit coding format in the set E1 (i.e. where at least one of the receive coding formats in the set E2 corresponds to at least one of the transmit coding formats of the set E1), the transmission of multimedia data from the terminal T1 to the terminal T2 can take place and the coding format which is used by the terminal T1 for encoding the data to be transmitted from T1 to T2 will be one of the formats which the terminal T2 is capable of decoding.

In contrast, if the terminal T2 cannot decode any of the transmit coding formats in the set E1 (none of the receive coding formats in the set E2 corresponds to a transmit coding format in the set E1), then it is not possible to transmit data from T1 to T2. This is the case shown in FIG. 1. Terminal T2 then informs the terminal T1 via the proxy server S. This step is represented in FIG. 1 by two arrows, one connecting the terminal T2 to the server S and the other connecting the server S to the terminal T1, with the instruction “606 Non Acceptable” written above said arrows.

These situations of incompatibility occur frequently when the communications system establishes calls between terminals having different capabilities and functions.

### OBJECTS AND SUMMARY OF THE INVENTION

An object of the invention is to minimize such situations of incompatibility.

One possible solution would consist in increasing the encoding and decoding abilities of all of the terminals in the communications system. Another solution would consist in making the encoding and decoding abilities of the terminals in the communications system uniform, i.e. in providing a system in which all of the terminals have identical encoding and decoding means. Those two solutions are expensive since they require either a large number of encoding and decoding means in each terminal of the system, or else regular updating of the encoding and decoding means of all of the terminals so that all of them have substantially the same encoding and decoding formats, and preferably the most recent formats.

The idea underlying the invention is to enrich the set of encoding formats virtually in each terminal of the system when transmitting to another terminal.

For this purpose, provision is made to connect coding format converter means to the server S and to use the server to enlarge the sets of transmit coding formats.

Thus, the invention provides a method of selecting multimedia data coding formats in a communications system having at least two terminals suitable for exchanging multimedia data with each other, each terminal having a set of coding formats listing those formats which it is capable of processing on reception and those which it is capable of applying to multimedia data on transmission,

wherein, prior to any exchange of multimedia data between two terminals of the communications system, the method comprises the following steps:

at least one of the two terminals sends its set of coding formats to a server of the communications system that is itself in communication with means for converting the coding format of the multimedia data that is to be exchanged;

if necessary to enable multimedia data exchange to take place, the server enlarges the or each set of coding formats received from one of said two terminals as a function of the conversion means available to it, and it sends the possibly enlarged set to the other one of said two terminals; and

each terminal receiving an enlarged set from the other one of said two terminals selects a receive coding format from amongst those which it is capable of processing on reception and that the other one of said two terminals is capable of applying in transmission as listed in its enlarged set and/or a transmit coding format from amongst those which it is capable of applying in transmission and which the other one of said terminals is capable of processing in reception, as listed in its enlarged set.

This serves to increase the encoding abilities of the terminals in the system in virtual manner.

The invention also provides a communications system comprising:

at least two terminals suitable for exchanging multimedia data between each other, each terminal having a set of coding formats listing those formats which it is capable of processing in reception and those formats which it is capable of applying to multimedia data in transmission; and

a server for acting prior to any exchange of multimedia data between two terminals of the communications system to transmit the set of coding formats of at least one of said two terminals to the other,

wherein the server is connected to means for converting the coding format of multimedia data that is to be exchanged; and

wherein the server acts, if necessary to enable multimedia data exchange to take place, to enlarge the or each set of coding formats received from one of said two terminals as a function of the conversion means available to it prior to sending said possibly enlarged set to the other one of said two terminals.

According to an important characteristic of the invention, each terminal further comprises means for selecting a receive coding format from amongst those which it is capable of processing in reception and which the other of said two terminals is capable of applying in transmission as listed in its possibly enlarged set, and/or a transmit coding format from amongst those which it is capable of applying in transmission and which the other one of said two terminals is capable of processing in reception, as listed in its possibly enlarged set.

### BRIEF DESCRIPTION OF THE DRAWINGS

Other characteristics and advantages of the invention appear on reading the following description given by way of non-limiting example with reference to the accompanying drawings, in which:

FIG. 1, described above, shows an encoding format being selected in a prior art communications system;

FIG. 2 shows a coding format being selected in accordance with the invention in a communications system having two SIP terminals; and

FIG. 3 shows a coding format being selected in accordance with the invention in a communications system having two H323 terminals.

### MORE DETAILED DESCRIPTION

In the invention, provision is made to enlarge each set of coding formats received by the server S, if necessary and wherever possible, prior to forwarding the possibly enlarged set to a terminal of the system. For this purpose, the server S is connected to means for converting, where appropriate, the coding format of multimedia data exchanged between terminals of the system.

Thus, in the invention, when the server S receives a set of coding formats, it acts where possible to add formats to that set, should added formats be necessary for exchanging data, the added formats being determined as a function of the conversion means available to the server.

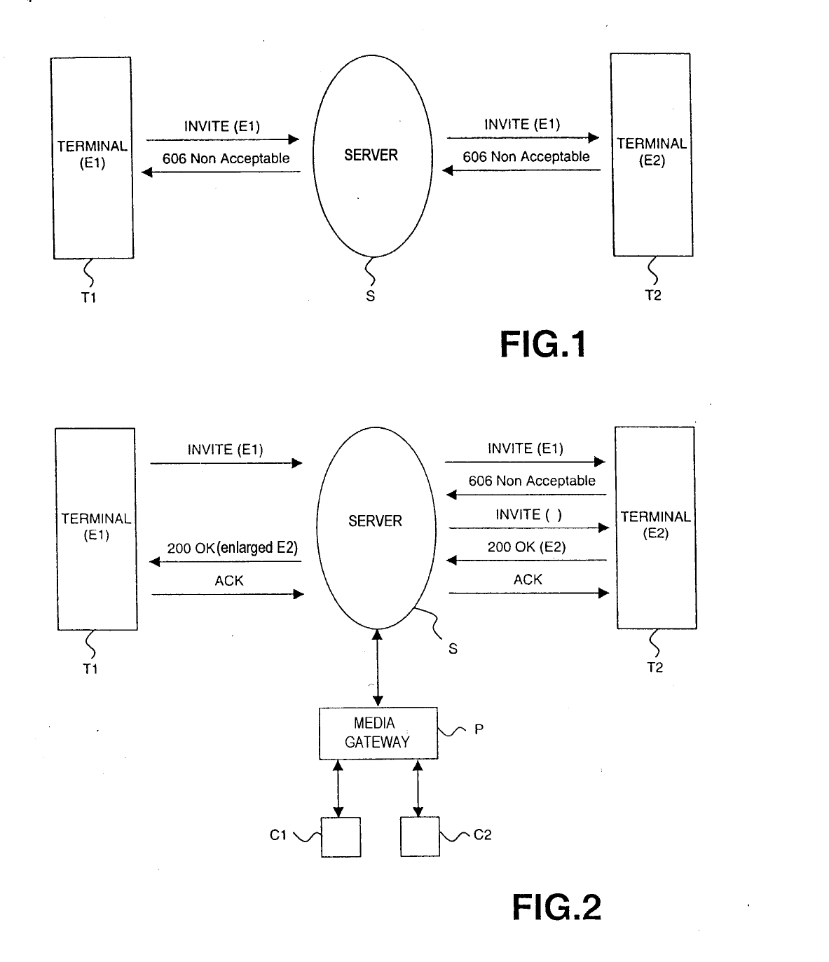

The method of the invention is illustrated by FIG. 2 which, like FIG. 1, relates to a communications system having two SIP terminals T1 and T2 and a proxy server S. Three steps of FIG. 1 as represented by the instructions “INVITE(E1)”, “INVITE(E1)”, and “606 Non Acceptable” are reproduced in FIG. 2. At this stage, the server S knows that the terminal T2 is not able to decode multimedia data as encoded by the terminal T1. The server S then invites the terminal T2 to communicate its set of coding formats E2. This step is represented in the figure by the instruction “INVITE( )”. Terminal T2 responds by sending its set E2 to the server S, i.e. instruction “200 OK (E2)”.

The server 2 then adds to the set E2 that it has received as a function of the conversion means that are available to the server. In FIG. 2, the server S is in communication with coding format converter means C1, C2 via a media gateway P.

The step of adding to the coding format set as received by the server S can be illustrated by means of an example that is very simple. For example, if the set E2 received by server S includes a coding format A and the conversion means enable the coding format A to be converted into a coding format B, then the set E2 with added formats will include both coding formats A and B.

The server S then sends the enlarged set E2 to the terminal T1 with the instruction “200 OK (enlarged E2)”.

The terminal T1 then selects a transmit coding format that is comprised both within the transmit coding formats of the set E1 and the receive coding formats of the set E2. It also selects a receive coding format comprised both within the receive coding formats of the set E1 and the transmit coding formats of the set E2.

Thereafter, the terminal T1 sends the transmit and receive formats it has chosen to the server S, by the instruction “ACK”. The server S modifies these coding formats so that they correspond respectively to a receive coding format and a transmit coding format of the set E2 and then transmits them as modified in this way to the terminal T2. During this step, the server S reserves means in the media gateway P as required for converting the coding formats selected by the terminal T1.

Multimedia data can then be transmitted between the terminals T1 and T2 using the selected coding formats. The multimedia data passes via the media gateway P which converts the multimedia data coding format, where necessary, using the conversion circuits reserved by the server S.

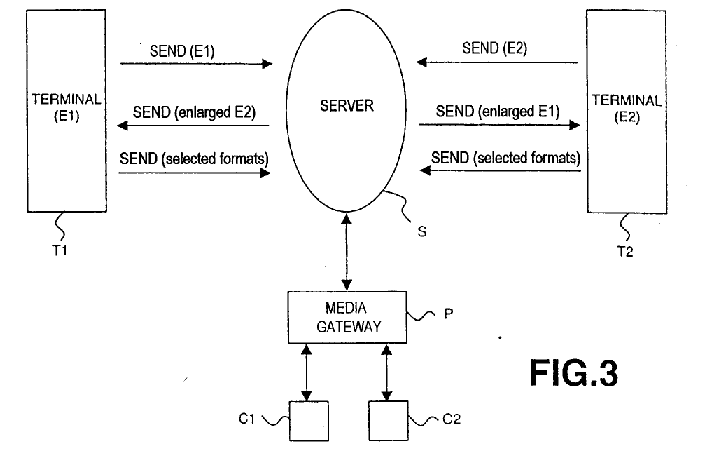

FIG. 3 shows how coding format is selected in a communications system having terminals operating using the H323 protocol. As in FIG. 2, the system has two terminals T1 and T2, a server S which in this case is an access control server, and means for converting coding formats C1 and C2 connected to the server S via a media gateway P. Prior to any multimedia data exchange between the terminals T1 and T2, both of these terminals send their respective coding format sets E1 and E2 to the server S.

In the invention, if none of the transmit or receive coding formats in the set E1 corresponds respectively to receive or transmit coding formats in the set E2, the server S enlarges said sets as a function of the conversion means available to it, so that it becomes possible for multimedia data to be transmitted between the terminals T1 and T2.

Thereafter, the server S sends the enlarged set E1 to the terminal T2 and the enlarged set E2 to the terminal T1. Each of the terminals T1 and T2 then selects a transmit and a receive coding format as in the system of FIG. 2. Thereafter each terminal sends the coding format it has selected to the server S so that the server can reserve the necessary conversion means in the media gateway so as to convert between the coding formats selected by the terminal T1 and those selected by the terminal T2.

What is claimed is:

1/ A method of selecting multimedia data coding formats in a communications system having at least two terminals suitable for exchanging multimedia data with each other, each terminal having a set of coding formats listing those formats which it is capable of processing on reception and those which it is capable of applying to multimedia data on transmission,
wherein, prior to any exchange of multimedia data between two terminals of the communications system, the method comprises the following steps:
at least one of the two terminals sends its set of coding formats to a server of the communications system that is itself in communication with means for converting the coding format of the multimedia data that is to be exchanged;
if necessary to enable multimedia data exchange to take place, the server enlarges the or each set of coding formats received from one of said two terminals as a function of the conversion means available to it, and it sends the possibly enlarged set to the other one of said two terminals; and
each terminal receiving an enlarged set from the other one of said two terminals selects a receive coding format from amongst those which it is capable of processing on reception and that the other one of said two terminals is capable of applying in transmission as listed in its enlarged set and/or a transmit coding format from amongst those which it is capable of applying in transmission and which the other one of said terminals is capable of processing in reception, as listed in its enlarged set.

2/ A method of selection according to claim 1, wherein said terminals operate using the SIP protocol, and wherein the server is a proxy server.

3/ A method of selection according to claim 1, wherein said terminals operate using the H323 protocol, and wherein the server is an access controller.

4/ A communications system comprising:
at least two terminals suitable for exchanging multimedia data between each other, each terminal having a set of coding formats listing those formats which it is capable of processing in reception and those formats which it is capable of applying to multimedia data in transmission; and
a server for acting prior to any exchange of multimedia data between two terminals of the communications system to transmit the set of coding formats of at least one of said two terminals to the other,
wherein the server is connected to means for converting the coding format of multimedia data that is to be exchanged; and
wherein the server acts, if necessary to enable multimedia data exchange to take place, to enlarge the or each set of coding formats received from one of said two terminals as a function of the conversion means available to it prior to sending said possibly enlarged set to the other one of said two terminals.

5/ A communications system according to claim 4, wherein each terminal further comprises means for selecting a receive coding format from amongst those which it is capable of processing in reception and which the other of said two terminals is capable of applying in transmission as listed in its possibly enlarged set, and/or a transmit coding format from amongst those which it is capable of applying in transmission and which the other one of said two terminals is capable of processing in reception, as listed in its possibly enlarged set.

6/ A communications system according to claim 4, wherein the server is connected to the conversion means via a media gateway.

7/ A communications system according to claim 4, wherein said terminals operate using SIP protocol and wherein the server is a proxy server.

8/ A communications system according to claim 4, wherein said terminals operate using the H323 protocol, and wherein the server is an access controller.
